(19) United States
(12) Patent Application Publication
(10) Pub. No.: US 2004/0000989 A1
(43) Pub. Date: Jan. 1, 2004

(54) Vehicle monitoring system that uses a cellular telephone to notify of vehicle tampering

(76) Inventor: Glenn A. Davis, Ilford (GB)

Correspondence Address: DONALD R. SCHOONOVER, 4211 ROLLING HILLS DRIVE, NIXA, MO, 65714-8771, US

(21) Appl. No.: 10/183,303

(22) Filed: Jun. 28, 2002

(51) Int. Cl. B60R 25/10

(52) U.S. Cl. 340/426.2

(57) ABSTRACT

A vehicle monitoring system includes sensors located on a vehicle and which are connected to a receiver/transmitter that transmits a signal of an event sensed by the sensors via a cellular telephone network to a cellular telephone. A keyboard unit is mounted on the vehicle at a location spaced apart from the receiver/transmitter and is used to program the system to dial specified telephone numbers and to react in ways that are appropriate and desired to monitor a vehicle.

### BACKGROUND OF THE INVENTION

1. Field of the Invention

The present invention relates to the general art of vehicles, and to the particular field of anti-theft and anti-tampering monitoring and alarm systems for vehicles.

2. Discussion of the Related Art

As has been well documented, vehicle theft is a huge problem, not only in the United States and Great Britain, but throughout the world. In some areas, it has been estimated that a thief can break into and steal a vehicle in a matter of mere seconds. The vehicle can then be stolen, transported away and lost in a matter of minutes. Insurance rates in many areas are at all-time highs because of the prevalence of such theft. Even beyond actual theft, vandalism has also taken its toll on vehicles and insurance rates associated therewith.

Accordingly, the art of vehicle alarms has become vast and contains many examples of vehicle alarms and anti-theft devices. These systems range from simple locks, to devices that disable portions of the vehicle to sophisticated electrical systems. However, as statistics thoroughly prove, there is much room for improvements in the field of vehicle anti-theft and anti-tampering monitoring and alarm systems.

Therefore, there is a need for a vehicle anti-theft and anti-tampering system that is an improvement over existing systems.

For the purposes of the present disclosure, the term “vehicle” is intended to include air, land and water vehicles, and the term “protection alarm system” is intended to include anti-theft systems as well as anti-tampering alarm systems as well as monitoring systems.

Many of the presently-available vehicle protection alarm systems generally include some form of visible and/or audible signal when triggered. The most common example of this is the car anti-theft system that activates the car lights and the car horn when activated. While such systems may be effective in some situations, such systems have many shortcomings. For example, while a casual thief or an opportunistic thief may be frightened off by such systems, a professional thief will not be frightened. In fact, a professional thief may be into the vehicle quickly enough to de-activate the system before the alarm system even activates sufficiently to be effective.

Still further, such alarm systems are generally localized. That is, the system can only be detected near the vehicle. Many thefts and break-ins occur when a vehicle is parked far from the owner. For example, many thefts occur in a parking lot when the vehicle owner is miles away. If the vehicle is in an airport parking lot, the owner may be thousands of miles away. Such local alarms will not be at all effective in alerting the distant owner that his or her vehicle is being broken into or is being tampered with. In such an instance, the owner is dependent on the good will of those who may be in the vicinity of the vehicle to act as good Samaritans and try to protect his or her vehicle. While this may be effective in some situations, it is not as reliable as it should be.

Therefore, there is a need for a vehicle protection alarm system that will be able to alert a vehicle owner who may be located far away from the vehicle.

Still further, there is a need for a vehicle protection alarm system that will alert a vehicle owner in a manner that will permit the owner to alert the authorities that the vehicle is being tampered with whereby the vehicle owner is not dependent on the help of someone who may be in the vicinity.

Many presently-available vehicle alarm systems are defeatable by even casual thieves, and certainly by professional thieves. The thief knows where to find the control system for the alarm system and then knows how to defeat that control system in a manner that prevents the alarm system from activating. Many presently-available alarm systems are designed to be convenient to the vehicle owner for operation. Thus, a vehicle alarm system might be activated by the vehicle owner activating a button located on the dashboard of the vehicle, or on the door of the vehicle, or the like.

However, if the control system is convenient to the vehicle owner, it is also convenient to a thief. Therefore, many of the presently-available alarm systems are defeated simply because the control unit therefor is easily accessed by a potential thief.

Therefore, there is a need for a vehicle protection alarm system that is not easily located but can still be convenient for the vehicle owner to activate and operate.

Still further, many presently-available vehicle alarm systems do not properly notify the vehicle owner that the alarm system is defective or has failed. In such a case, the system is less than defective, it can actually be self-defeating because the vehicle owner is under the false impression that the vehicle protection alarm system is properly operating when, in fact, it may not be.

Therefore, there is a need for a vehicle protection alarm system that can notify a vehicle owner that the protection alarm system is not operating at full capacity, or actually has failed.

Still further, when a vehicle alarm is activated, it is often difficult to identify which vehicle is being broken into or tampered with. Thus, even if the vehicle owner is nearby, he or she may not be aware that it is his or her vehicle that is sounding an alarm. In such an instance, the owner may actually ignore the alarm.

Therefore, there is a need for a vehicle protection alarm system that will alert a vehicle owner that it is his or her vehicle that is being broken into or tampered with.

Still further, sophisticated vehicle alarms may have to be installed at the vehicle factory, or by a skilled technician having access to specialized tools. This may make such systems expensive, and prevent a vehicle from being retrofit with an effective alarm system. A vehicle protection alarm system is most effective if it activates an alarm for a wide variety of incidents, including, but not limited to, break in, tampering, jacking the vehicle up, theft of elements from the vehicle, and the like. However, many presently-available vehicle protection alarm systems do not include sensors for all such events, and it may be difficult and complicated to include additional sensors.

Therefore, there is a need for a vehicle protection alarm system that is easily fit and/or retrofit onto a vehicle.

There is a further need for a vehicle protection alarm system that can protect a vehicle from a wide range of incidents without becoming overly-complex and expensive.

### PRINCIPAL OBJECTS OF THE INVENTION

It is a main object of the present invention to provide a vehicle protection alarm system that is an improvement over existing systems.

It is another object of the present invention to provide a vehicle protection alarm system that will be able to alert a vehicle owner who may be located far away from the vehicle.

It is another object of the present invention to provide a vehicle protection alarm system that will alert a vehicle owner in a manner that will permit the owner to alert the authorities that the vehicle is being tampered with whereby the vehicle owner is not dependent on the help of someone who may be in the vicinity.

It is another object of the present invention to provide a vehicle protection alarm system that is not easily located but can still be convenient for the vehicle owner to activate and operate.

It is another object of the present invention to provide a vehicle protection alarm system that can notify a vehicle owner that the protection alarm system is not operating at full capacity, or actually has failed.

It is another object of the present invention to provide a vehicle protection alarm system that will alert a vehicle owner that it is his or her vehicle that is being broken into or tampered with.

It is another object of the present invention to provide a vehicle protection alarm system that is easily fit and/or retrofit onto a vehicle.

It is another object of the present invention to provide a vehicle protection alarm system that can protect a vehicle from a wide range of incidents without becoming overly-complex and expensive.

### SUMMARY OF THE INVENTION

These, and other, objects are achieved by an anti-theft, anti-tamper alarm system that is used on a vehicle, such as a land vehicle, a water vehicle or even an airplane, that includes a hidden receiver/transmitter unit which is separate from a control unit that may be located for convenient operation, and which alerts an owner of the vehicle of an event via the owner's cellular telephone.

Since more and more people are carrying a cell phone, communication via a cellular network can be convenient and reliable. In this manner, an owner is alerted accurately and effectively no matter where he or she is when an unwanted event is occurring with respect to their vehicle. This also permits the owner to notify appropriate authorities in a timely manner. It also permits the alarm and monitoring system to monitor a wide variety of events and to notify the owner exactly which event is occurring so the owner can accurately and efficiently notify authorities.

The unit that transmits the alarm signal is hidden in an inaccessible location while the control unit is located in a convenient and accessible location, such as on the dashboard of an automobile or even on an outside surface of the vehicle. While a potential thief or vandal may gain access to the control unit, he cannot gain access to the receiver/transmitter unit which can be programmed to generate an alarm signal associated with tampering with the control unit itself.

The system embodying the present invention thus is reliable, accurate and specific to the owner of the particular vehicle that is being tampered with or broken into. The system further notifies the owner no matter where he or she is with respect to the vehicle and notifies the owner in a manner that permits the owner to take effective and immediate action. The system embodying the present invention is easy to fit and/or retrofit onto a vehicle and yet will be safe from access by a potential thief or vandal.

### BRIEF DESCRIPTION OF THE DRAWING FIGURES

FIG. 1 is a rear perspective view of an automobile with a protection alarm system embodying the present invention thereon.

FIG. 2 is a perspective view of a receiver/transmitter unit used in the system embodying the present invention.

FIG. 3 is a perspective view of a control keyboard unit used in the system embodying the present invention.

FIG. 4 is a block diagram illustrating operation of the system embodying the present invention.

FIG. 5 is a block diagram illustrating use of the control keyboard unit of the present invention.

### DETAILED DESCRIPTION OF THE INVENTION

Other objects, features and advantages of the invention will become apparent from a consideration of the following detailed description and the accompanying drawings.

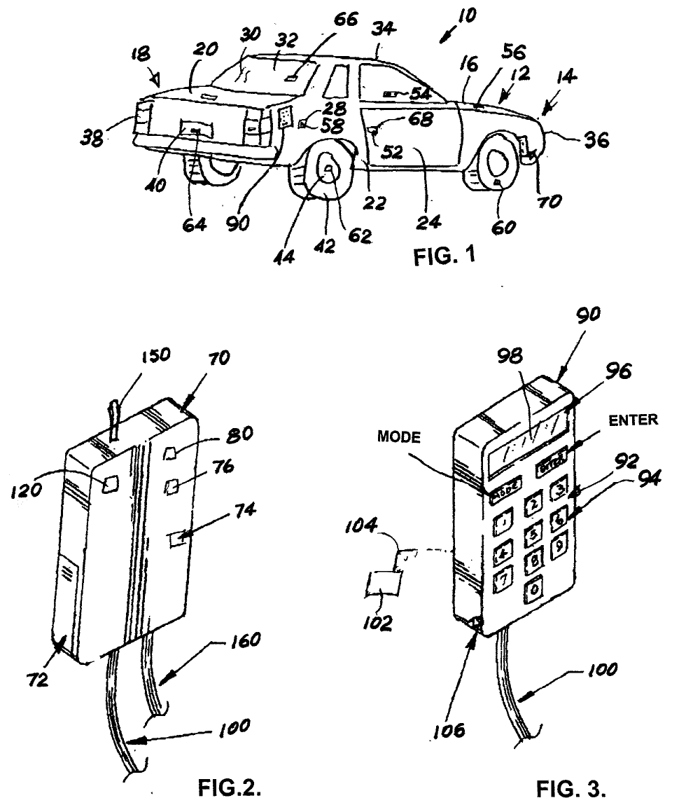

Referring to FIGS. 1-3, it can be understood that the present invention is used in association with a vehicle, such as an automobile 10, or the like, to protect that vehicle from unauthorized events, including, but not limited to, theft, tampering, or the like. Those skilled in the art will be able to understand other unauthorized events and it is intended that such additional events also are within the scope of the present disclosure.

As shown in FIG. 1, vehicle 10 includes a body 12 having a front 14 with a hood 16, a rear 18 having a trunk 20, sides 22 having doors 24 and windows 26. Vehicle 10 can also include a gas tank cover 28 as well as an antenna 30 that can be embedded in one of the vehicle windows, such as rear window 32. Vehicle 10 further includes a top 34 and vehicle lights, such as headlight 36 and taillight 38. A license plate 40 is attached to either or both ends of the vehicle. The vehicle also includes wheels 42 having hubcaps 44 as well as windshield wipers and other accessories that will be known to those skilled in the art.

As discussed above, vehicle theft and/or vandalism is a major problem. Vehicle theft may require a thief to break into the vehicle, and theft and/or vandalism may require a perpetrator to damage or tamper with one or more elements of the vehicle.

The vehicle alarm protection system embodying the present invention will immediately and accurately alert a vehicle owner that the vehicle 10 is being tampered with in an unauthorized manner no matter where the owner is relative to the vehicle 10 and will alert that owner in a manner that the owner can immediately and effectively alert authorities of exactly the type of activity occurring. The system embodying the present invention also is very difficult, if not impossible, to defeat because part of the system can be hidden and located in a position that is totally inaccessible and unknown to a potential thief or vandal, while part of the system is located in a convenient location. The conveniently-located portion of the system may actually decoy a potential thief or vandal into trying to disable the system by tampering with the portion of the system that is visible and accessible to him. This makes the system embodying the present invention even more effective.

Referring to FIGS. 2 and 3, it can be understood that the present invention is embodied in an anti-theft and anti-tampering alarm protection system for a vehicle and which comprises a plurality of event sensors, located on the vehicle at various locations on the vehicle for sensing an event associated with unauthorized use of the vehicle. The event sensors can be located on doors, such as sensor 52, on door windows, such as event sensor 54, on the hood, such as event sensor 56, on a gas cap cover, such as event sensor 58, on wheels, such as event sensor 60, on hubcaps, such as event sensor 62, on the license plate, such as event sensor 64, on various windows, such as event sensor 66 on rear window 32, or the like. Other event sensors, including tilt sensors, light sensors, motion detectors, sound alarms, smoke alarms, carbon monoxide alarms, fire alarms or the like will be understood by one skilled in the art based on the teaching of the present disclosure. Such other event sensors are intended to be included in the scope of the present disclosure as well. Each event sensor includes a signal generator, indicated on event sensor 52 at reference number 68, which generates an event signal when the sensor associated therewith is activated by an unauthorized use of the vehicle.

The system of the present invention further includes a receiver/transmitter unit 70 electrically connected to each event sensor of the plurality of event sensors and which includes a power supply 72, a signal receiver circuit 74 which receives event signals generated by any of the event sensors and a transmitter circuit 76 electrically connected to the signal receiver circuit 74 and which generates and transmits an alarm signal in response to the signal receiver circuit 74 receiving an event signal.

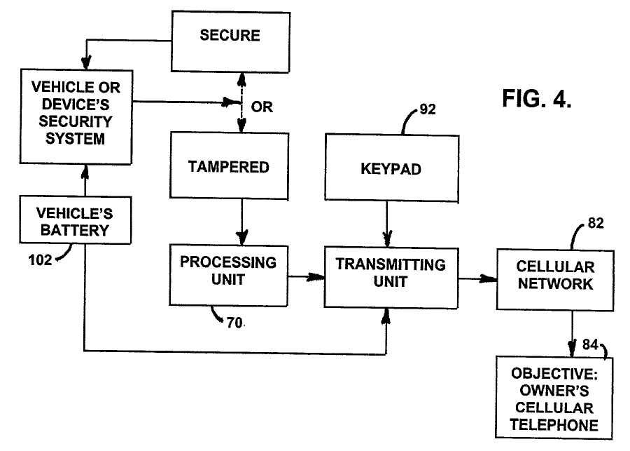

The receiver/transmitter unit 70 is mounted on the vehicle 10 at a hidden location spaced apart from any of the event sensors. The hidden location can be beneath the hood 16 or in a wheel well, such as indicated in FIG. 1. The transmitter circuit 76 of the receiver/transmitter unit 70 includes a circuit 80 which generates alarm signals via a cellular network over-the-air communications system (indicated at 82 in FIG. 4).

The system of the present invention further includes a cellular telephone 84 (see FIG. 4) connected to the cellular network 82 to receive alarm signals generated by the transmitter circuit 76 of the receiver/transmitter unit 70. The signals received on the cellular telephone 84 can be readouts of the precise sensor activated, as well as any other information that may be desired by a vehicle owner.

The system of the present invention further includes a control keyboard unit 90 mounted on the vehicle 10 at a second location, such as on a rear fender as shown in FIG. 1, but could also be at any other convenient location, spaced apart from any of the event sensors and spaced apart from the receiver/transmitter unit 70. The control keyboard unit 90 includes a control input keypad 92 having a plurality of input buttons, such as input button 94, a display section 96 connected to the input buttons of the control input keypad 92 and having means, such as display screen 98, for visually displaying information associated with each input button as each input button is activated. Each input button generates a control signal when activated, as will be understood by those skilled in the art. The keyboard unit 90 further includes an electrical connection 100 between the input buttons of the control input keypad 92 and the transmitter/receiver unit 70 which transfers control signals from the control input keyboard to the transmitter/receiver unit 70. The keyboard unit 90 further includes a second power supply, such as a vehicle battery 102 or the like, an electrical connection 104 between the control keyboard unit 90 and the second power supply. The keyboard unit 90 can also include an event sensor 106 on the control keyboard unit 90 to signal tampering with the keyboard unit 90.

The receiver/transmitter unit 70 further includes a control circuit 120 electrically connected to the control keyboard unit 90 to receive control signals from the control keyboard unit 90 and which controls operation of the receiver/transmitter unit 70 according to codes associated with the control signals received by the receiver/transmitter unit 70 from the control keyboard unit 90. The control circuits will not be discussed in detail since the exact form of such circuits will be understood by those skilled in the art based on the teaching of the present disclosure.

Referring to FIG. 4, operation of the system of the present invention can be understood. As can be understood from FIG. 4, sensors are located on the vehicle 10 and are powered from the vehicle's battery 102. The sensors monitor the vehicle 10 to determine if it is “secure,” that is, untampered with, or if tampered with, will generate a signal that is transmitted to the receiver portion of the receiver/transmitter unit 70, identified in FIG. 4 as the processing unit. The processing unit 70 of the receiver/transmitter then sends the signal to the transmitting portion of the receiver/transmitter unit 70 which has been programmed from the keyboard unit with appropriate telephone numbers and the like. The transmitting unit is connected to a cellular network 82, via an antenna 150 (see FIG. 2) and transmits this signal via the cellular network 82 to a cellular telephone 84 of the vehicle owner or other person designated to receive the signal by having possession of the cellular telephone.

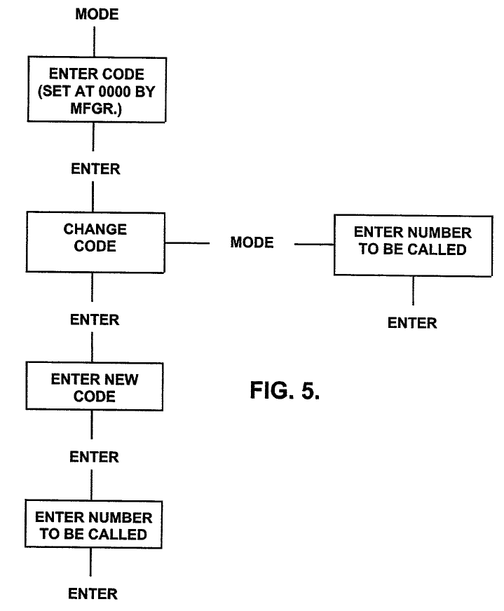

As shown in FIG. 5, the keyboard unit is programmed with appropriate codes corresponding to telephone numbers, such as the cellular telephone of the vehicle owner, appropriate authorities, or the like, and corresponding to the various conditions sensed by the sensors using a system and process well known in the art. For example, the keyboard includes keys 0 to 9 as well as two operational keys MODE and ENTER. Nothing will be shown on the display section until the MODE key is pressed. Once this has been done, an “ENTER CODE” message will appear on the visual display 98.

This code is set by the manufacturer to “0000”. Once this had been entered by using the numbered keys, the ENTER key is pressed. If the code that has been entered is incorrect, an “INCORRECT CODE” message will show in the display 98 for a specified period of time, such as five seconds, followed by the “ENTER CODE” message again.

Once the correct code has been entered, the display 98 will then give the owner of the device the chance to change the code by giving the message “CHANGE CODE”. If the owner wishes to change the code, the “ENTER” button is pressed. The next message to be displayed will be “ENTER A NEW CODE”. The user does this by using the numbered keys followed by the “ENTER” key. This process is then repeated to confirm the new code. If the code that is entered the first time differs from the code that is entered the second time, the display 98 will show “CODES ERROR” for a specified time, such as five seconds, followed by the “ENTER NEW CODE” display. That process is repeated until the confirmed code matches that of the code that was entered first.

If the user does not wish to change the code when the “CHANGE CODE” message is displayed, the user presses the “MODE” key. The display will then show “ENTER NUMBER TO BE CALLED”. The user does this by using the numbered keys followed by the “ENTER” key when the cellular telephone number that is to be called has been entered. This process is repeated to confirm that the correct telephone number has been entered. Once the confirmed telephone number matches the first telephone number entered, that number is stored in the device's memory, which is situated in the processing unit 70. Of course, the codes can be deleted or changed if the ownership of the vehicle changes.

It is also noted that, in addition to the power from power supply 72, the receiver/transmitter unit 70 can be powered from another source, such as the vehicle's battery 102. The system of the present invention can also be used in conjunction with an existing security system such as a factory-installed system or the like. This is indicated in FIG. 2 by the receiver/transmitter unit 70 being electrically connected to another security system via an electrical connection 160. This feature permits a retrofit to be performed. Furthermore, the system of the present invention can include self-monitoring circuits that are connected to the receiver/transmitter unit 70 to generate a signal that corresponds to a failure or a defect in one or more of the sensors or even in the receiver/transmitter unit 70 or the keyboard unit. The self-monitoring circuits can be programmed to send a signal that will be read by the user's cell phone as a system defect message so the user can either notify the proper authorities or shut the system off using his or her cell phone and codes that have been programmed into the system.

It is understood that while certain forms of the present invention have been illustrated and described herein, it is not to be limited to the specific forms or arrangements of parts described and shown.

I claim:

1. An anti-theft and anti-tampering alarm protection system for a vehicle comprising:
a) a plurality of event sensors located on a vehicle at various locations on the vehicle for sensing an event associated with unauthorized use of the vehicle, each event sensor including a signal generator which generates an event signal when the sensor associated therewith is activated by an unauthorized use of the vehicle;
b) a receiver/transmitter unit electrically connected to each event sensor of said plurality of event sensors and which includes a power supply, a signal receiver circuit which receives event signals generated by any of the event sensors and a transmitter circuit electrically connected to the signal receiver circuit and which generates and transmits an alarm signal in response to the signal receiver circuit receiving an event signal;
c) said receiver/transmitter unit being mounted on the vehicle at a hidden location spaced apart from any of the event sensors;
d) the transmitter circuit of said receiver/transmitter unit including a circuit which generates alarm signals via a cellular network over-the-air communications system;
e) a cellular telephone connected to the cellular network to receive alarm signals generated by the transmitter circuit of said receiver/transmitter unit;
f) a control keyboard unit mounted on the vehicle at a second location spaced apart from any of the event sensors and spaced apart from said receiver/transmitter unit;
g) said control keyboard unit including
(1) a control input keypad having a plurality of input buttons,
(2) a display section connected to the input buttons of the control input keypad and having means for visually displaying information associated with each input button as each input button is activated, each input button generating a control signal when activated,
(3) an electrical connection between the input buttons of the control input keypad and said transmitter/receiver unit which transfers control signals from the control input keyboard to said transmitter/receiver unit,
(4) a second power supply,
(5) an electrical connection between said control keyboard unit and the second power supply, and
(6) an event sensor on said control keyboard unit; and
h) said receiver/transmitter unit further including a control circuit electrically connected to said control keyboard unit to receive control signals from said control keyboard unit and controlling operation of said receiver/transmitter unit according to codes associated with the control signals received by said receiver/transmitter unit from said control keyboard unit.

2. The anti-theft and anti-tampering alarm protection system as described in claim 1 further including an electrical connection between said receiver/transmitter unit and a power source associated with the vehicle.

3. The anti-theft and anti-tampering alarm protection system as described in claim 1 further including an antenna on said receiver/transmitter unit which is electrically connected to the transmitter circuit of said receiver/transmitter unit.
